(19) United States
(12) Patent Application Publication
(10) Pub. No.: US 2023/0367534 A1
(43) Pub. Date: Nov. 16, 2023

(54) APPLICATION PROTECTION FOR SCREEN SHARING

(71) Applicant: Citrix Systems, Inc., Fort Lauderdale, FL (US)

(72) Inventors: Kai Cui, Nanjing (CN); Shunli Ren, Nanjing (CN); Zhen Fan, Nanjing (CN)

(21) Appl. No.: 17/808,345

(22) Filed: Jun. 23, 2022

Related U.S. Application Data
(63) Continuation of application No. PCT/CN2022/092380, filed on May 12, 2022.

(51) Int. Cl. G06F 3/14; G06F 21/83; G06F 21/84; G06F 3/0481

(52) U.S. Cl. CPC G06F 3/1454; G06F 21/83; G06F 21/84; G06F 3/0481; G06F 2221/032

(57) ABSTRACT

In one aspect, an example methodology implementing the disclosed techniques can include, by a computing device, receiving input events from a remote computing device, ones of the input events having an input event position associated with a position on a screen of the computing device being shared during a screen sharing session and, responsive to a determination that a first input event position of a first one of the input events is within a protected region of the shared screen, preventing the first one of the input events from being applied to the shared screen. The method can also include, by the computing device, responsive to a determination that a second input event position of a second one of the input events is not within the protected region of the shared screen, applying the second one of the input events to the shared screen.

### CROSS REFERENCE TO RELATED APPLICATIONS

This application is a continuation of and claims the benefit of PCT Patent Application No. PCT/CN2022/092380 filed on May 12, 2022 in the English language in the State Intellectual Property Office and designating the United States, the contents of which are hereby incorporated herein by reference in its entirety.

### BACKGROUND

Screen sharing enables a user to share digital content displayed on their local computing device with users of other, remote computing devices in real-time or near real-time. For example, a user can share their desktop screen with other users during a screen sharing session. Various online meeting and conferencing services, such as TEAMS, SKYPE, ZOOM, GOTOMEETING, and WEBEX, provide screen sharing capabilities in addition to audio and video conferencing. Various remote access software, such as GOTOMYPC, also provide screen sharing capabilities which allow a user to share their computer screen with any user online. Using such services and applications, a user can share their desktop, which allows other users who are invited to take part in the screen sharing session to view all the applications, data, and content on the shared screen.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

Existing applications and services that provide screen sharing allow a user to give remote control of their screen to another user. For example, a user (a “sharer”) who is sharing their desktop during a screen sharing session can allow another user who is viewing the shared screen (a “viewer”) to take remote control of the shared desktop screen. Once given control, the viewer can manipulate the sharer's desktop screen by clicking on things, editing, or typing using an input device, such as a mouse or keyboard, of the viewer's computing device. However, allowing the viewer to take remote control of the shared desktop screen can lead to unintended results. For example, an input event, such as a mouse click, may occur at a different position on the shared desktop screen than intended by the viewer due to network delay between the viewer's computing device and the sharer's computing device. Depending on the input event, an undesirable action can occur on the sharer's computing device such as a deletion of a data file or application appearing on the shared desktop screen, termination of the screen sharing, or shutting down of the sharer's computing device. This can lead to loss of user productivity for both the sharer and viewer. Embodiments of the present disclosure can address the aforementioned technical problems by monitoring input events during remote control of a shared screen during screen sharing session and, based on the position of an input event on the shared screen, prevent the input event from being applied to the shared screen.

In accordance with one example embodiment provided to illustrate the broader concepts, systems, and techniques described herein, a method includes by a computing device, receiving input events from a remote computing device, ones of the input events having an input event position associated with a position on a screen of the computing device being shared during a screen sharing session and, responsive to a determination that a first input event position of a first one of the input events is within a protected region of the shared screen, preventing the first one of the input events from being applied to the shared screen. The method also includes, by the computing device, responsive to a determination that a second input event position of a second one of the input events is not within the protected region of the shared screen, applying the second one of the input events to the shared screen.

In some embodiments, the input event is a mouse event. In some embodiments, the shared screen includes a shared desktop of the computing device.

In some embodiments, the protected region of the shared screen includes a display of at least a window of a protected application. In one aspect, the protected application is specified by a user of the computing device. In one aspect, the protected application is specified in a screen sharing policy.

In some embodiments, the method further includes, by the computing device, determining the protected region of the shared screen by tracking a current position of a display of a window of a protected application on the shared screen.

In some embodiments, the method further includes, by the computing device, upon applying the second one of the plurality of events to the shared screen, providing contents of the shared screen to the remote computing device to be rendered on a screen of the remote computing device.

According to another illustrative embodiment provided to illustrate the broader concepts described herein, a system includes a system includes a processor and a non-volatile memory storing computer program code that when executed on the processor, causes the processor to execute a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4 is a diagram of an illustrative network environment for application protection during screen sharing, in accordance with an embodiment of the present disclosure.

FIG. 5 is a block diagram of an illustrative client that can be used within the network environment of FIG. 4, in accordance with an embodiment of the present disclosure.

FIG. 6 is a diagram illustrating interactions between various components of two clients of FIG. 5 to provide application protection during a screen sharing session, in accordance with an embodiment of the present disclosure.

FIG. 7 is a sequence diagram showing an example flow of interactions between various components to protect applications during screen sharing, in accordance with an embodiment of the present disclosure.

### DETAILED DESCRIPTION

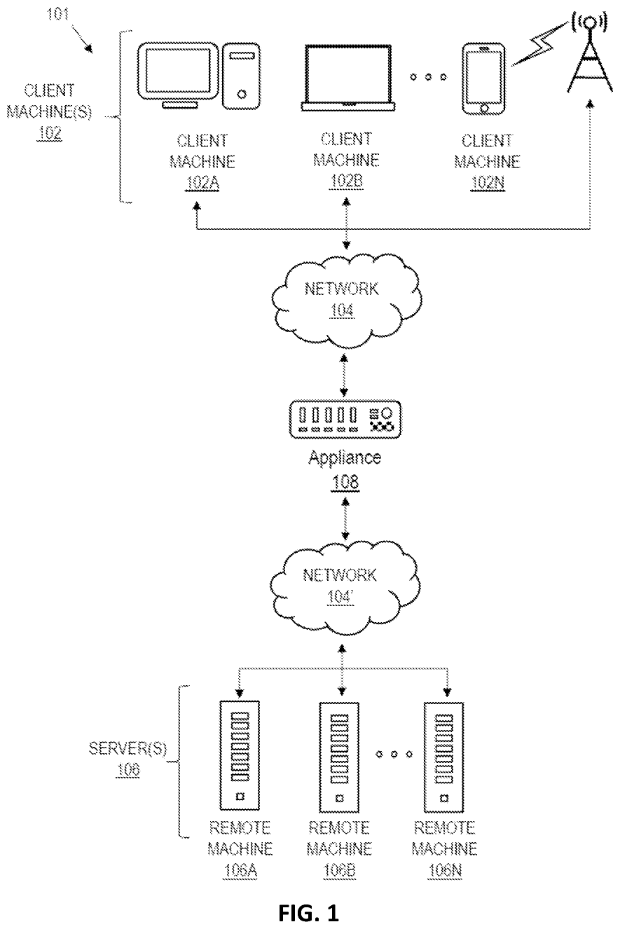

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

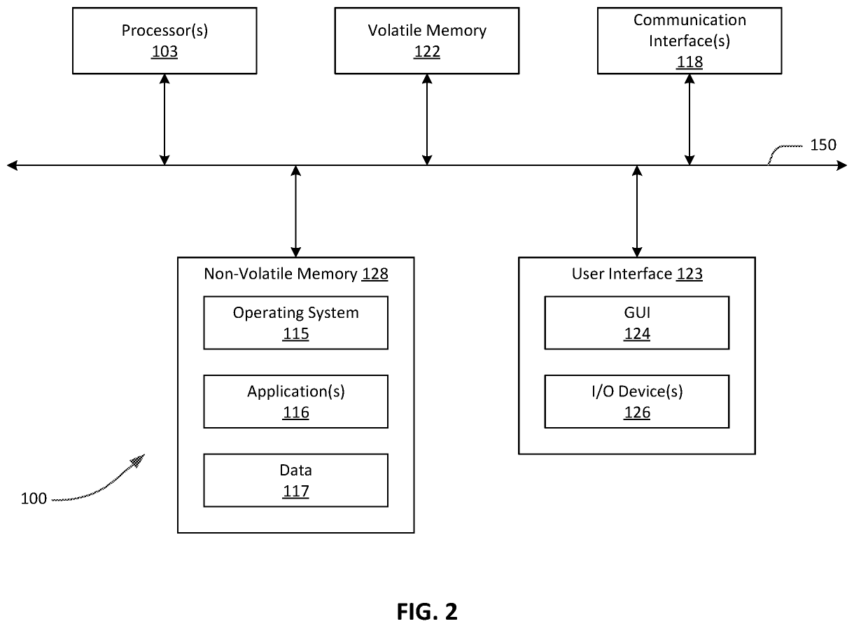

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

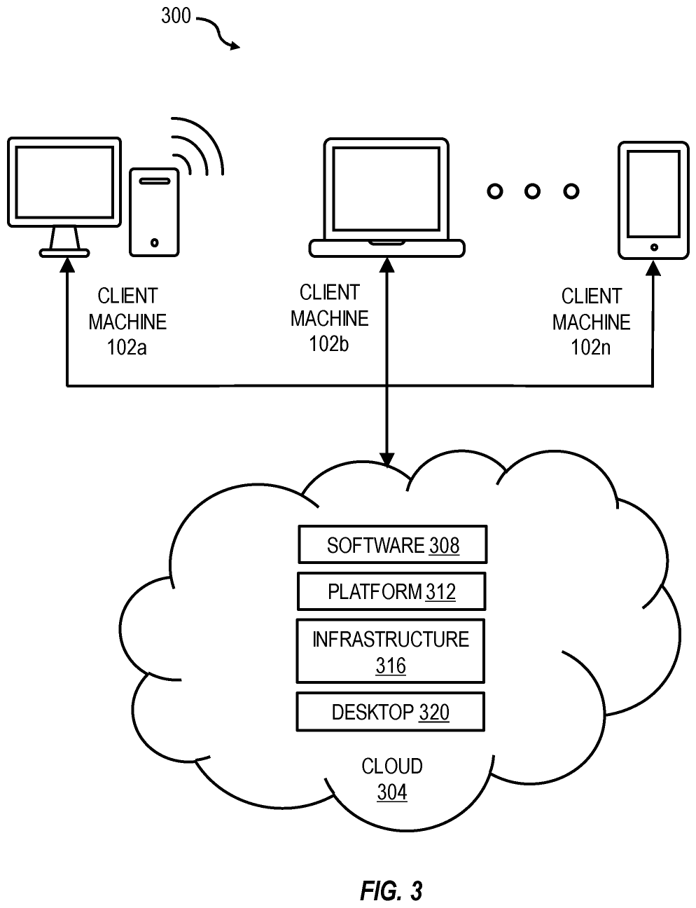

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

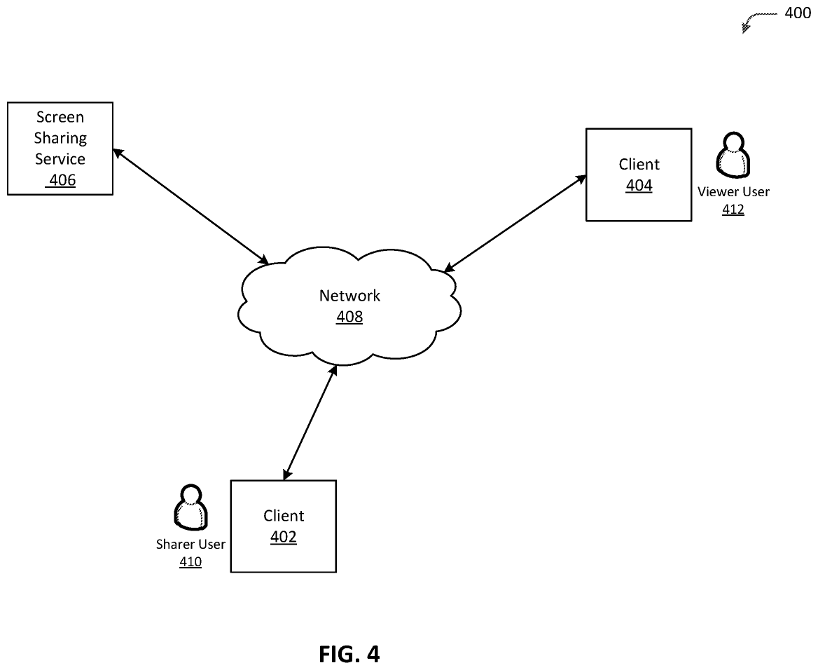

FIG. 4 is a diagram of an illustrative network environment 400 for application protection during screen sharing, in accordance with an embodiment of the present disclosure. As shown, illustrative network environment 400 includes a first client 402, a second client 404, and a screen sharing service 406. Clients 402, 404 may be configured to communicate with meeting service 406 via one or more computer networks 408 (e.g., via the Internet). In some embodiments, clients 402, 404 may communicate directly with each other, e.g., using peer-to-peer (P2P) communication, as discussed further below.

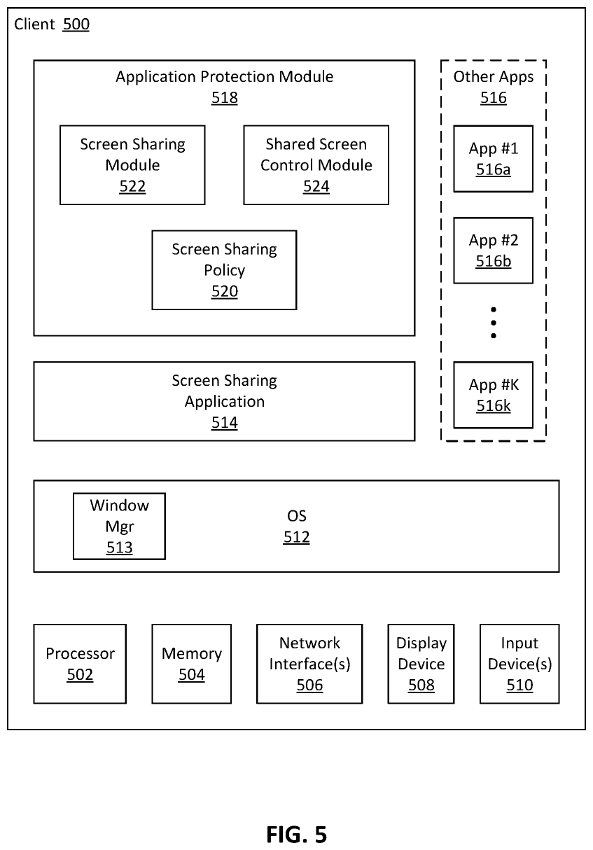

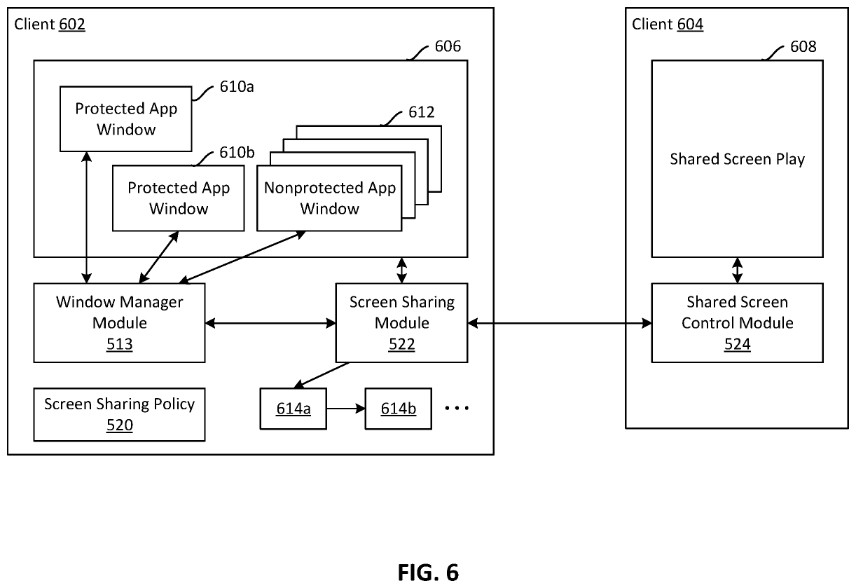

In the example of FIG. 4, a sharing user 410 can use first client (or “sharer client”) 402 to share their screen with a viewing user 412 using second client (or “viewer client”) 404. Client 402, 404 can include, for example, desktop computing devices, laptop computing devices, tablet computing devices, and/or mobile computing devices. Clients 402, 404 can be configured to run one or more applications, such as desktop applications, mobile applications, and SaaS applications. Among various other types of applications, clients 402, 404 can run an application that provides screen sharing functionality (referred to generally as a “screen sharing application”). For example, clients 402, 404 can run an online meeting application, such as TEAMS, SKYPE, ZOOM, GOTOMEETING, WEBEX, or another meeting application, that provides screen sharing. The screen sharing application running on clients 402, 404 can communicate with screen sharing service 406 and/or with screen sharing applications running on other clients 402, 404 (e.g., using P2P communication). In some embodiments, a client 402, 404 may be the same or substantially similar to a client machine 102A-102N described above in the context of FIG. 1 and FIG. 3 and/or computing device 100 described above in the context of FIG. 2. An example of a client that may be the same as or similar to sharer client 402 and/or viewer client 404 is described below with respect to FIG. 6. While only one viewer client 404 is shown in FIG. 5, the structures and techniques sought to be protected herein can be applied to any number of viewers and viewer clients.

Screen sharing service 406 may correspond to any service that enables sharer client 402 to share its desktop screen with viewer client 404. For example, screen sharing service 406 may correspond to an online meeting service such as TEAMS, SKYPE, ZOOM, GOTOMEETING, WEBEX, etc. In some embodiments, screen sharing service 406 may correspond to a SaaS or DaaS application (e.g., a virtual desktop application) running in the cloud (e.g., within cloud network 304 of FIG. 3). In some embodiments, screen sharing service 406 may be omitted and screen sharing applications running on clients 402, 404 may directly communicate with each other using P2P communication.

Sharer client 402 can establish a screen sharing session with viewer client 404 via screen sharing service 406. In some embodiments, sharer client 402 can directly establish a screen sharing session with viewer client 404 using P2P. Sharing user 410 can share an entire screen (or “desktop”) visible on sharer client 402 with viewing user 412, meaning that any applications, icons, and other content that are visible on the sharer's screen are also visible on viewer client 404.

During the screen sharing session, sharing user 410 may relinquish control of the shared desktop screen on sharer client 402 to viewing user 412. Once given control, viewing user 412 may manipulate the shared desktop screen on sharer client 402 by providing inputs (“input events”) using an input device, such as a mouse or keyboard, connected to or otherwise associated with viewer client 404. For example, viewing the shared desktop screen displayed on viewer client 404, viewing user 412 may use the mouse connected to viewer client 404 to select an icon that is visible on the shared desktop screen. Using the techniques and structures disclosed herein, sharer client 402 may determine whether the viewer's input event is to a protected application on the shared desktop screen and, in response to determining that the input event is to a protected application, prevent the input event from being applied to the shared desktop screen.

FIG. 5 is a block diagram of an illustrative client 500 that can be used within network environment 400 of FIG. 4, in accordance with an embodiment of the present disclosure. For example, client 500 can correspond to sharer client 402 and/or viewer client 404 of FIG. 4. Illustrative client 500 can include a processor 502, a memory 504, one or more network interfaces 506, a display device 508, and one or more input devices 510. Memory 504 can store executable instructions for an operating system (OS) and one or more applications, and processor 502 can be configured to execute/run the OS and applications using the stored executable instructions. Display device 508 may be provided, for example, as a monitor or a touchscreen device. Input devices 510 may include, for example, a mouse, a keyboard, a touchpad, a touchscreen, or a stylus, to provide a few examples.

Client 500 can also include an OS 512, a screen sharing application 514, and one or more other applications 516a, 516b, . . . , 516k (516 generally). Screen sharing application 514 may correspond to any application that enables client 500 to share its screen with other clients and/or to display screens shared by other clients. In some embodiments, screen sharing application 514 may include an online meeting application such as TEAMS, SKYPE, ZOOM, GOTOMEETING, WEBEX, etc. Screen sharing application 514 may connect to a screen sharing service (e.g., screen sharing service 406 of FIG. 4) via one or more computer networks (e.g., networks 408 of FIG. 4) to establish a screen sharing session with one or more other clients.

Other applications 516 can include any applications configured to run on client 500 besides screen sharing application 514. Each of the other applications 516 may have an identifier (e.g., a name, a path, a numeric identifier, etc.) that identifies the application on client 500. A given one of the other applications 516 can include a UI (or “window”) having one or more UI elements. A given one of the other applications 516 can be represented by an icon (e.g., a selectable image that represents an application). Using screen sharing application 514, a user of client 500 can choose to share their entire screen including the icons and UIs of other applications 516 that are running and visible on the screen.

In some embodiments, client 500 may include a desktop environment whereby a given application can be displayed within one or more desktops. For example, the desktop environment may be provided by OS 512. Non-limiting examples of OS's that can provide desktop environments include WINDOWS, MACOS, CHROME OS, and various LINUX/UNIX distributions. In such embodiments, the user may choose to share a particular desktop. In other words, the user may choose to share all application windows and icons visible within the desktop environment (i.e., visible on the desktop screen). At any given time, client 500 may have an arbitrary number of applications (e.g., tens of applications) that are running and visible (e.g., open applications) on a desktop screen displayed on display device 508 of client 500. Client 500 may also have an arbitrary number of icons and other content that are visible on the desktop screen. An application, or application window, may be considered “visible” if at least a portion of the application/window is displayed on a desktop screen (e.g., if it is visible to a user of client 500). Various OS's allow applications to run in the background, sometimes referred to as services, daemon processes, or non-interactive processes. Such running applications may be considered not visible for the purpose of this disclosure. In addition, various desktop environments allow a user to hide/minimize applications and application windows. Such running applications/windows may also be considered not visible for the purposes of this disclosure.

As shown in FIG. 5, OS 512 can include a submodule such as a window manager 513. Window manager 513 is configured to manage the placement and appearance of windows (“application windows”), icons, and content (sometimes collectively referred to herein more simply as “windows”) displayed within a root window (e.g., on a desktop screen). In more detail, window manager 513 can manage the creation of windows by various applications (e.g., screen sharing application 514 and/or other applications 516) on client 500 that share the desktop screen. For example, in response to requests from applications to create windows, window manager 513 can determine the actual size and position of the windows displayed on the desktop screen, and determine which windows obscure other windows in cases where windows overlap (e.g., which windows are visible when windows overlap). Window manager 513 can determine which window receives user input at any given time. Window manager 513 can provide an interface (e.g., an Application Programming Interface (API)) via which applications can send requests for information (e.g., size, position, stacking order, etc.) regarding the windows, icons, and other objects displayed within the desktop screen.

Client 500 can further include an application protection module 518 configured to determine whether an input event during remote control of a shared desktop screen is to a protected application and, responsive to a determination that the input event is to a protected application, prevent the input event from being applied to the shared desktop screen. The input event may be provided by a viewer using another client (e.g., viewing user 412 using client 404 of FIG. 4) to remotely control the shared desktop screen during a screen sharing session, transmitted to client 500 via one or more computer networks (e.g., networks 408 of FIG. 4), and received via network interfaces 506. For example, if a sharer who is using client 500 relinquishes control of the shared desktop screen on client 500 to a viewer using another client, application protection module 518 may monitor the viewer's input events during the remote control of the shared desktop screen.

As shown in FIG. 5, application protection module 518 can include submodules such as a screen sharing policy 520, a screen sharing module 522, and a shared screen control module 524. Screen sharing policy 520 can include information regarding the applications (e.g., one or more other applications 516) that need to be protected from input events during remote control of a shared desktop screen during. In other words, input events are not to be applied to these applications while the shared desktop screen is under remote control. Such applications indicated in screen sharing policy 520 are sometimes referred to herein as “protected applications.” Screen sharing policy 520 may be defined by a sharer using client 500 to share its screen with other clients. As one example, the sharer may specify in screen sharing policy 520 that a shutdown menu icon displayed within the desktop screen is a protected application. As another example, the sharer may specify in screen sharing policy 520 that a mission-critical application 516 running on client 500 is a protected application. Screen sharing module 522 can then use screen sharing policy 520 to determine the applications that should be protected (i.e., the protected applications) during a screen sharing session (e.g., sharer's screen sharing session). In some embodiments, the protected applications may be configured as view-only during a screen sharing session.

In response to an input event from a viewer client during a screen sharing session, screen sharing module 522 can apply or not apply (e.g., prevent) the input event to the shared screen (e.g., a shared desktop screen) based on screen sharing policy 520. In more detail, during the screen sharing session, screen sharing module 522 can track the windows that are visible on the shared screen. For example, in one embodiment, screen sharing module 522 may register with window manager 513 to receive notifications regarding each window displayed on the shared screen (e.g., opening a window, moving a window, resizing a window, hiding a window, minimizing a window, closing a window, etc.). Such notifications from window manager 513 may include information regarding the window such as size, position, application identifier, top-level property (i.e., whether the window is a top-level window), and other attributes of the window. Screen sharing module 522 can retrieve information regarding protected applications from screen sharing policy 520 and, with the window notification information from window manager 513, track the regions of the shared screen that are displaying windows of protected applications. In other words, screen sharing module 522 can track, in real-time or near real-time, regions of the shared screen (e.g., coordinates of the shared screen) in which windows of protected applications are displayed and visible. Such regions of a shared screen are sometimes referred to herein as “protected regions.” Screen sharing module 522 can then determine whether an input event from a viewer client is within a protected region of the shared screen. Note that a protected region of the shared screen is a region of the shared screen in which a window of a protected application is viewable. In response to a determination that the input event from the viewer client is within a protected region, screen sharing module 522 can prevent the input event from being applied to the shared screen. Otherwise (e.g., in response to a determination that the input event from the viewer client is not within a protected region), screen sharing module 522 can apply the input event to the shared screen.

Shared screen control module 524 can capture input events to a shared screen on a viewer client and send information regarding the captured input events to a sharer client. In more detail, shared screen control module 524 can operate on a viewer client which has obtained (e.g., gained) remote control of a screen (e.g., desktop screen) that is being shared by a sharer client. During remote control of the shared screen by the viewer client, shared screen control module 524 can capture input events to the shared screen. For a given input event captured on the viewer client, shared screen control module 524 can send information regarding the captured input event, such as the action associated with the input event (e.g., right-mouse-click, left-mouse-click, mouse-double-click, mouse-drag, press of an “enter” key on a keyboard, etc.) and the input event position or coordinates on the shared screen, to the sharer client.

Turning to FIG. 6 and with continued reference to FIG. 5, shown is a diagram illustrating interactions between various components of a client 602 and a client 604 to provide application protection during a screen sharing session, in accordance with an embodiment of the present disclosure. In the example of FIG. 6, a user (e.g., sharing user 410 of FIG. 4) using client 602 may be sharing a desktop screen 606 with a user (e.g., viewing user 412 of FIG. 4) using client 604. Clients 602, 604 can correspond to client 500 of FIG. 5.

During the screen sharing session, the contents of a desktop screen 606 on sharer client 602 may be shared with viewer client 604. For example, a screen sharing application (e.g., screen sharing application 514) on sharer client 602 may capture and send the contents of desktop screen 606 to a screen sharing application (e.g., screen sharing application 514) on viewer client 604, which displays (e.g., plays) the captured contents sent by sharer client 602 on a display screen 608 of viewer client 604. On sharer client 602, screen sharing module 522 may track the windows that are visible on desktop screen 606 in real-time or near real-time. For example, screen sharing module 522 can register event listeners with window manager 513 to receive notifications when window events or occurrences happen on desktop screen 606 (e.g., opening of windows, moving of windows/icons, resizing of windows, hiding of windows, closing of windows, etc., on desktop screen 606).

In response to a notification of a window event, screen sharing module 522 can collect or gather information regarding the windows displayed on desktop screen 606 from window manager 513. In the example of FIG. 6, screen sharing module 522 can collect information regarding application windows 610a, 610b, and 612 that are displayed on desktop screen 606. Screen sharing module 522 can also retrieve information regarding any protected applications from screen sharing policy 520. Screen sharing policy 520, in one embodiment, is associated with a current user of sharer client 602 who is sharing desktop screen 606. Based on information collected from window manager 513 and information retrieved from screen sharing policy 520, screen sharing module 522 can determine which of the application windows displayed on desktop screen 606 are windows associated with a protected application and which of the application windows displayed on desktop 606 are windows associated with a nonprotected application. As shown in FIG. 6, screen sharing module 522 may determine that application windows 610a, 610b are associated with a protected application and application windows 612 are associated with a nonprotected application based on the information from window manager 513 and screen sharing policy 520. For each of the application windows displayed on desktop screen 606 associated with a protected application (e.g., protected application windows 610a, 610b), screen sharing module 522 can determine the regions of desktop screen 606 where the protected application window is displayed and visible. In other words, screen sharing module 522 can track the protected regions of desktop screen 606. In the example of FIG. 6, screen sharing module 522 can determine the regions of desktop screen 606 where protected application windows 610a, 610b are displayed and visible (e.g., determine the protected regions of desktop screen 606 corresponding to protected application windows 610a, 610b). Note that in cases of overlapping application windows, portions of an application window below another application window may not be visible.

As described previously, screen sharing module 522 can determine the regions of desktop screen 606 where protected application windows are displayed and visible (e.g., the protected regions of desktop screen 606) when notified of window events from window manager 513. This allows screen sharing module 522 to track the regions of desktop screen 606 in which protected application windows are visible. In some embodiments, screen sharing module 522 may maintain records of the protected regions of desktop screen 606 (e.g., position and size of the visible portions of the protected application windows on desktop screen 606) in memory (e.g., in RAM) where it can be updated as the protected regions are tracked. Screen sharing module 522 can subsequently access such records to determine whether an input event from a viewer client is within a protected region of desktop screen 606. As can be seen in FIG. 6, in one embodiment, screen sharing module 522 may use records 614 to track the protected regions of desktop screen 606. For example, information regarding the protected region corresponding to protected application window 610a may be maintained in a record 614a and information regarding the protected region corresponding to protected application window 610b may be maintained in a record 614b. While only two (2) protected application windows are depicted in the example of FIG. 6 for purposes of clarity, it will be appreciated that there may be a different number of protected application windows displayed on desktop screen 606.

Still referring to the example of FIG. 6, during the screen sharing session, sharer client 602 may relinquish control of desktop screen 606 to viewer client 604. Once given control, the user of viewer client 604 may remotely control shared desktop 606 by providing inputs to viewer client 604. For example, shared screen control module 524 on viewer client 604 can capture input events to desktop screen 606 being displayed (e.g., played) on display screen 608 of viewer client 604. Shared screen control module 524 can send the captured input events to sharer client 602, causing screen sharing module 522 on sharer client 602 to apply the input event to shared desktop 606 on sharer client 602. For example, suppose the user of viewer client 604 clicks/taps a UI element within a window displayed on shared desktop 606. Shared screen control module 524 on viewer client 604 can capture the input event (i.e., the click/tap of the UI element within the window displayed on shared desktop 606) and send information regarding the captured input event (e.g., the specific click/tap and the coordinate position of the click/tap within the window) to sharer client 602. In response to receiving the captured input event information from shared screen control module 524, screen sharing module 522 on sharer client 602 can determine whether the input event is within a protected region of shared desktop 606 on sharer client 602. That is, screen sharing module 522 on sharer client 602 can determine whether the position of the input event (e.g., coordinate position of the click/tap made by the user of viewer client 604) on shared desktop 606 is within a protected region of shared desktop 606 on sharer client 602. If the input event position is within a protected region of shared desktop 606, screen sharing module 522 on sharer client 602 can prevent the input event from being applied to shared desktop 606 on sharer client 602. Otherwise, if the input event position is not within a protected region of shared desktop 606, screen sharing module 522 on sharer client 602 can apply the input event to shared desktop 606 on sharer client 602.

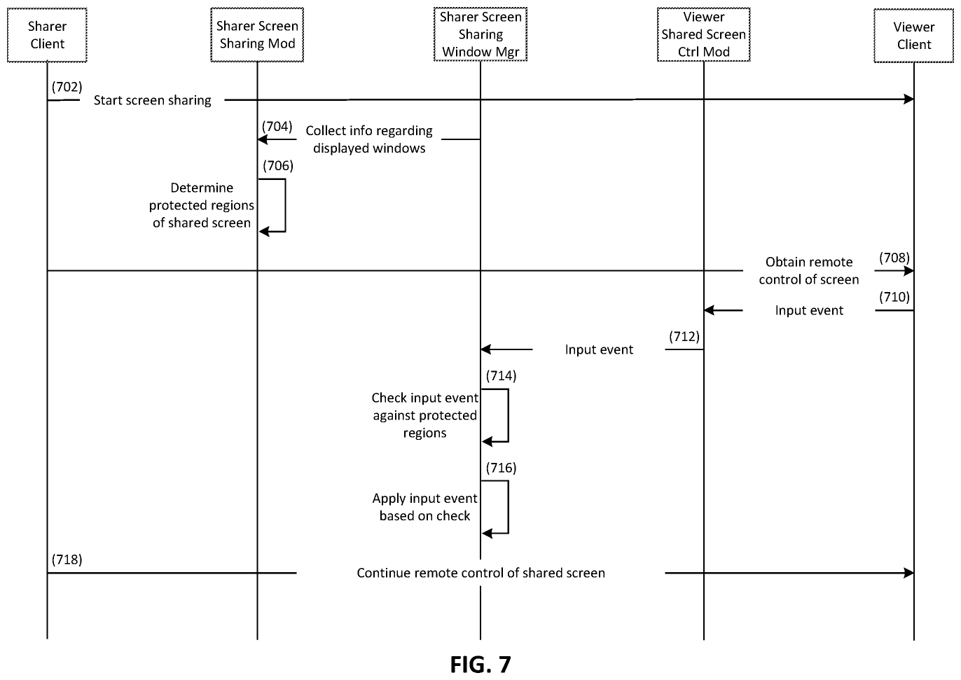

FIG. 7 is a sequence diagram showing an example flow of interactions between various components to protect applications during screen sharing, in accordance with an embodiment of the present disclosure. A first client device (e.g., sharer client 602 of FIG. 6) may establish (e.g., start) a screen sharing session (702) with a second client device (e.g., viewer client 604 of FIG. 6). For example, the screen sharing session may be to share a desktop screen on the first client device (e.g., desktop screen 606 of FIG. 6).

In response to the screen sharing session being established, a screen sharing module executing on the first client device (e.g., screen sharing module 522 of FIG. 6) may collect information regarding application windows displayed on the shared desktop screen (704) from a window manager (e.g., window manager module 513 of FIG. 6). The information regarding the displayed application windows may be collected from the window manager on a continuous basis. For example, the screen sharing module on the first client device may register event listeners with the window manager to receive notifications when window events happen on the shared desktop screen.

In response to collecting information regarding the displayed application windows, the screen sharing module on the first client device may use the information from the window manager and information from a screen sharing policy (e.g., screen sharing policy 520 of FIG. 6) to determine the protected regions of the shared desktop screen (706). The protected regions are the regions of the shared desktop screen in which windows of protected applications are displayed and visible.

At a point during the screen sharing session, the second client device may obtain remote control of the shared desktop screen (708). For example, during the screen sharing session, a user of the first client device may give control of the shared desktop screen to a user of the second client device.

While having remote control of the shared desktop screen, the second client device may capture an input event (710) made to the shared desktop screen being displayed on the first client device. For example, a shared screen control module executing on the second client device (e.g., shared screen control module 524 of FIG. 6) may capture the input event from (e.g., made by) the user of the second client device. The shared screen control module on the second client device may send the captured input event to the first client device (712).

In response to receiving the captured input event, the screen sharing module on the first client device may check the input event against the protected regions of the shared desktop screen (714). Here the check is to determine whether the position of the input event on the shared desktop screen is within a protected region of the shared desktop screen.

The screen sharing module on the first client device may then apply the input event to the shared desktop screen based on the check (716). For example, if the check determines that the position of the input event is within a protected region, the screen sharing module on the first client device may prevent the input event from being applied to the shared desktop screen. In this case, the input event will have no effect (e.g., effectively a no-op) on the shared desktop screen. Otherwise, if the check determines that the position of the input event is not within a protected region, the screen sharing module on the first client device may apply the input event to the shared desktop screen. The second client device may continue remote control of the shared desktop screen (718).

### Further Example Embodiments

The following examples pertain to further embodiments, from which numerous permutations and configurations will be apparent.

Example 1 includes a method including: receiving, by a computing device, a plurality of input events from a remote computing device, ones of the plurality of input events having an input event position associated with a position on a screen of the computing device being shared during a screen sharing session; responsive to a determination that a first input event position of a first one of the plurality of input events is within a protected region of the shared screen, preventing, by the computing device, the first one of the plurality of input events from being applied to the shared screen; and responsive to a determination that a second input event position of a second one of the plurality of input events is not within the protected region of the shared screen, applying, by the computing device, the second one of the plurality of input events to the shared screen.

Example 2 includes the subject matter of Example 1, wherein the input event is a mouse event.

Example 3 includes the subject matter of any of Examples 1 and 2, wherein the shared screen includes a shared desktop of the computing device.

Example 4 includes the subject matter of any of Examples 1 through 3, wherein the protected region of the shared screen includes a display of at least a window of a protected application.

Example 5 includes the subject matter of Example 4, wherein the protected application is specified by a user of the computing device.

Example 6 includes the subject matter of Example 4, wherein the protected application is specified in a screen sharing policy.

Example 7 includes the subject matter of any of Examples 1 through 6, further including determining, by the computing device, the protected region of the shared screen by tracking a current position of a display of a window of a protected application on the shared screen.

Example 8 includes the subject matter of any of Examples 1 through 7, further including, upon applying the second one of the plurality of events to the shared screen, providing, by the computing device, contents of the shared screen to the remote computing device to be rendered on a screen of the remote computing device.

Example 9 includes a system including a processor and a non-volatile memory storing computer program code that when executed on the processor causes the processor to execute a process operable to: receive a plurality of input events from a remote computing device, ones of the plurality of input events having an input event position associated with a position on a screen of the computing device being shared during a screen sharing session; responsive to a determination that a first input event position of a first one of the plurality of input events is within a protected region of the shared screen, prevent the first one of the plurality of input events from being applied to the shared screen; and responsive to a determination that a second input event position of a second one of the plurality of input events is not within the protected region of the shared screen, apply the second one of the plurality of input events to the shared screen.

Example 10 includes the subject matter of Example 9, wherein the input event is a mouse event.

Example 11 includes the subject matter of any of Examples 9 and 10, wherein the shared screen includes a shared desktop of the computing device.

Example 12 includes the subject matter of any of Examples 9 through 11, wherein the protected region of the shared screen includes a display of at least a window of a protected application.

Example 13 includes the subject matter of Example 12, wherein the protected application is specified by a user of the computing device.

Example 14 includes the subject matter of Example 12, wherein the protected application is specified in a screen sharing policy.

Example 15 includes the subject matter of any of Examples 9 through 14, wherein the process is further operable to determine the protected region of the shared screen by tracking a current position of a display of a window of a protected application on the shared screen.

Example 16 includes the subject matter of any of Examples 9 through 15, wherein the process is further operable to, upon application of the second one of the plurality of events to the shared screen, provide contents of the shared screen to the remote computing device to be rendered on a screen of the remote computing device.

Example 17 includes a non-transitory machine-readable medium encoding instructions that when executed by one or more processors cause a process to be carried out. The process includes: receiving a plurality of input events from a remote computing device, ones of the plurality of input events having an input event position associated with a position on a screen of the computing device being shared during a screen sharing session; responsive to a determination that a first input event position of a first one of the plurality of input events is within a protected region of the shared screen, preventing the first one of the plurality of input events from being applied to the shared screen; and, responsive to a determination that a second input event position of a second one of the plurality of input events is not within the protected region of the shared screen, applying the second one of the plurality of input events to the shared screen.

Example 18 includes the subject matter of Example 17, wherein the input event is a mouse event.

Example 19 includes the subject matter of any of Examples 17 and 18, wherein the shared screen includes a shared desktop of the computing device.

Example 20 includes the subject matter of any of Examples 17 through 19, wherein the protected region of the shared screen includes a display of at least a window of a protected application.

Example 21 includes the subject matter of Example 20, wherein the protected application is specified by a user of the computing device.

Example 22 includes the subject matter of Example 20, wherein the protected application is specified in a screen sharing policy.

Example 23 includes the subject matter of any of Examples 17 through 22, wherein the process further includes determining the protected region of the shared screen by tracking a current position of a display of a window of a protected application on the shared screen.

Example 24 includes the subject matter of any of Examples 17 through 23, wherein the process further included, upon applying the second one of the plurality of events to the shared screen, providing contents of the shared screen to the remote computing device to be rendered on a screen of the remote computing device.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
receiving, by a computing device, a plurality of input events from a remote computing device, ones of the plurality of input events having an input event position associated with a position on a screen of the computing device being shared during a screen sharing session;
responsive to a determination that a first input event position of a first one of the plurality of input events is within a protected region of the shared screen, preventing, by the computing device, the first one of the plurality of input events from being applied to the shared screen; and
responsive to a determination that a second input event position of a second one of the plurality of input events is not within the protected region of the shared screen, applying, by the computing device, the second one of the plurality of input events to the shared screen.

2. The method of claim 1, wherein the input event is a mouse event.

3. The method of claim 1, wherein the shared screen includes a shared desktop of the computing device.

4. The method of claim 1, wherein the protected region of the shared screen includes a display of at least a window of a protected application.

5. The method of claim 4, wherein the protected application is specified by a user of the computing device.

6. The method of claim 4, wherein the protected application is specified in a screen sharing policy.

7. The method of claim 1, further comprising determining, by the computing device, the protected region of the shared screen by tracking a current position of a display of a window of a protected application on the shared screen.

8. The method of claim 1, further comprising, upon applying the second one of the plurality of events to the shared screen, providing, by the computing device, contents of the shared screen to the remote computing device to be rendered on a screen of the remote computing device.

9. A system comprising:
a processor; and
a non-volatile memory storing computer program code that when executed on the processor causes the processor to execute a process operable to:
receive a plurality of input events from a remote computing device, ones of the plurality of input events having an input event position associated with a position on a screen of the computing device being shared during a screen sharing session;
responsive to a determination that a first input event position of a first one of the plurality of input events is within a protected region of the shared screen, prevent the first one of the plurality of input events from being applied to the shared screen; and
responsive to a determination that a second input event position of a second one of the plurality of input events is not within the protected region of the shared screen, apply the second one of the plurality of input events to the shared screen.

10. The system of claim 9, wherein the input event is a mouse event.

11. The system of claim 9, wherein the shared screen includes a shared desktop of the computing device.

12. The system of claim 9, wherein the protected region of the shared screen includes a display of at least a window of a protected application.

13. The system of claim 12, wherein the protected application is specified by a user of the computing device.

14. The system of claim 12, wherein the protected application is specified in a screen sharing policy.

15. The system of claim 9, wherein the process is further operable to determine the protected region of the shared screen by tracking a current position of a display of a window of a protected application on the shared screen.

16. The system of claim 9, wherein the process is further operable to, upon application of the second one of the plurality of events to the shared screen, provide contents of the shared screen to the remote computing device to be rendered on a screen of the remote computing device.

17. A non-transitory machine-readable medium encoding instructions that when executed by one or more processors cause a process to be carried out, the process comprising:
receiving a plurality of input events from a remote computing device, ones of the plurality of input events having an input event position associated with a position on a screen of the computing device being shared during a screen sharing session;
responsive to a determination that a first input event position of a first one of the plurality of input events is within a protected region of the shared screen, preventing the first one of the plurality of input events from being applied to the shared screen; and
responsive to a determination that a second input event position of a second one of the plurality of input events is not within the protected region of the shared screen, applying the second one of the plurality of input events to the shared screen.

18. The machine-readable medium of claim 17, wherein the shared screen includes a shared desktop of the computing device.

19. The machine-readable medium of claim 17, wherein the protected region of the shared screen includes a display of at least a window of a protected application.

20. The machine-readable medium of claim 17, wherein the process further comprises determining the protected region of the shared screen by tracking a current position of a display of a window of a protected application on the shared screen.
